(19) United States
(12) Patent Application Publication
(10) Pub. No.: US 2006/0246882 A1
(43) Pub. Date: Nov. 2, 2006

(54) Intelligent call forwarding via RFID technology

(75) Inventors: Wolfgang Frank, San Diego, CA (US); Georg Brambach, San Diego, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/118,798

(22) Filed: Apr. 29, 2005

(51) Int. Cl. H04M 3/42

(52) U.S. Cl. 455/417

(57) ABSTRACT

A system and method for selectively providing call forwarding from a mobile communication device to a telephone number includes a radio frequency identification (RFID) device associated with the telephone number. The mobile communication device interrogates the RFID device when the mobile communication device is in proximity to the RFID device. The RFID device responds by transmitting an identifier for identifying a telephone number to the mobile communication device. The identifier may include an identification code, a telephone number, a pointer, or the like. The mobile communication device may then selectively provide call forwarding to the telephone number identified from the identifier provided by the RFID device.

### BACKGROUND OF THE INVENTION

The present invention relates generally to the field of mobile communication devices such as mobile telephones, pagers, telephony equipped hand-held computers, or the like, and more particularly, to a system and method for selectively providing call forwarding from a mobile communication device to a telephone number associated with a radio frequency identification (RFID) device, such as an RFID tag, or the like.

Mobile communication devices such as mobile telephones, pagers, telephony equipped hand-held computers, or the like, often provide a call forwarding feature which allows the user to have calls placed to the mobile communication device forwarded to another telephone number, such as the telephone number of a land-line telephone in the user's home or office. This feature is particularly useful in places where wireless (e.g., cellular) telephone coverage is degraded such as buildings with thick walls or which use metal in their construction, building basements, or the like.

In conventional mobile communication devices, call forwarding to a second telephone number must be manually enabled by the user, who must select the call forwarding feature and then enter the telephone number to which calls placed to the mobile communication device are to be forwarded. Such manual entry of information is normally sufficient if the user wishes to have calls forwarded to a telephone having a known telephone number for a relatively long period of time. However, manual entry is often inefficient and time consuming if the user does not know the telephone number of the telephone to which the user wishes calls to be forwarded, or if the user wishes the call to be forwarded from the mobile communication device to several different telephones having different telephone numbers or extensions in a relatively short period of time.

Known to the art are automatic call forwarding systems that include mobile telephones and land-line telephones which are equipped with internal transceivers, wherein the transceiver of the land-line telephone initiates a communication link with the mobile telephone to provide automatic call forwarding from the mobile telephone to the land-line telephone. However, the implementation of such systems requires the use of special transceiver-equipped land-line telephones. Thus, in order to retrofit an existing telephone network with such a call forwarding system, the land line telephones in the network must be replaced with transceiver-equipped telephones of the system. Consequently, retrofit of existing automatic call forwarding systems is prohibitively expensive in networks having a large number of land-line telephones.

Accordingly, it would be desirable to provide a system and method for selectively providing automatic call forwarding from a mobile telephone to the telephone number which does not require the use of specialized land-line telephones.

### SUMMARY OF THE INVENTION

The present invention is directed to a system and method for selectively providing automatic call forwarding from a mobile communication device to a telephone number associated with a radio frequency identification (RFID) device, such as an RFID tag, or the like, in proximity to the mobile communication device. The mobile communication device interrogates the RFID device via a radio frequency (RF) signal when the mobile communication device is in proximity to the RFID device. The RFID device responds by transmitting an RF signal including identifying information for identifying a telephone number to the mobile communication device. The identifying information may include an identification code, a telephone number, a pointer, or the like. The mobile communication device may then selectively provide call forwarding to a telephone number identified from the identifier provided by the RFID device. In this manner, the system and method of the present invention may provide automatic call forwarding from the mobile communication device to the telephone number without the use of specialized land-line telephones.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a diagrammatic illustration of a system for providing for selectively providing automatic call forwarding to a telephone number associated with a radio frequency identification (RFID) device in accordance with an exemplary embodiment of the present invention, wherein the system includes a mobile telephone having a given transmission range and an RFID tag;

FIG. 2 is a diagrammatic illustration of an RFID tag including a transmission range and a mobile telephone in accordance with an exemplary embodiment of the present invention;

FIG. 3 is a block diagram of a mobile telephone in accordance with an exemplary embodiment of the present invention;

FIG. 4 is a diagrammatic illustration of a mobile telephone, an RFID tag, and a land-line telephone, wherein the RFID tag is associated with the land-line telephone and identifies a telephone number of the land-line telephone to the mobile telephone in accordance with an exemplary embodiment of the present invention;

FIG. 5 is a diagrammatic illustration of RFID tags placed in a variety of areas and associated with telephones which may be located in those areas in accordance with an exemplary embodiment of the present invention;

FIG. 6A is an illustration of a call forwarding menu user interface provided by a mobile telephone in accordance with an exemplary embodiment of the present invention;

FIG. 6B illustrates a database for access and/or modification via the user interface illustrated in FIG. 6A, in accordance with an exemplary embodiment of the present invention;

FIG. 7 is a method for providing call forwarding from a mobile telephone to a telephone number identified by an RFID tag in proximity to the mobile telephone in accordance with an exemplary embodiment of the present invention; and

FIG. 8 is a flow diagram illustrating a method for providing call forwarding from a mobile telephone to a telephone number identified by an RFID tag in proximity to the mobile telephone in accordance with an exemplary embodiment of the present invention.

### DETAILED DESCRIPTION OF SPECIFIC EMBODIMENTS

Reference will now be made in detail to the presently preferred embodiments of the invention, examples of which are illustrated in the accompanying drawings.

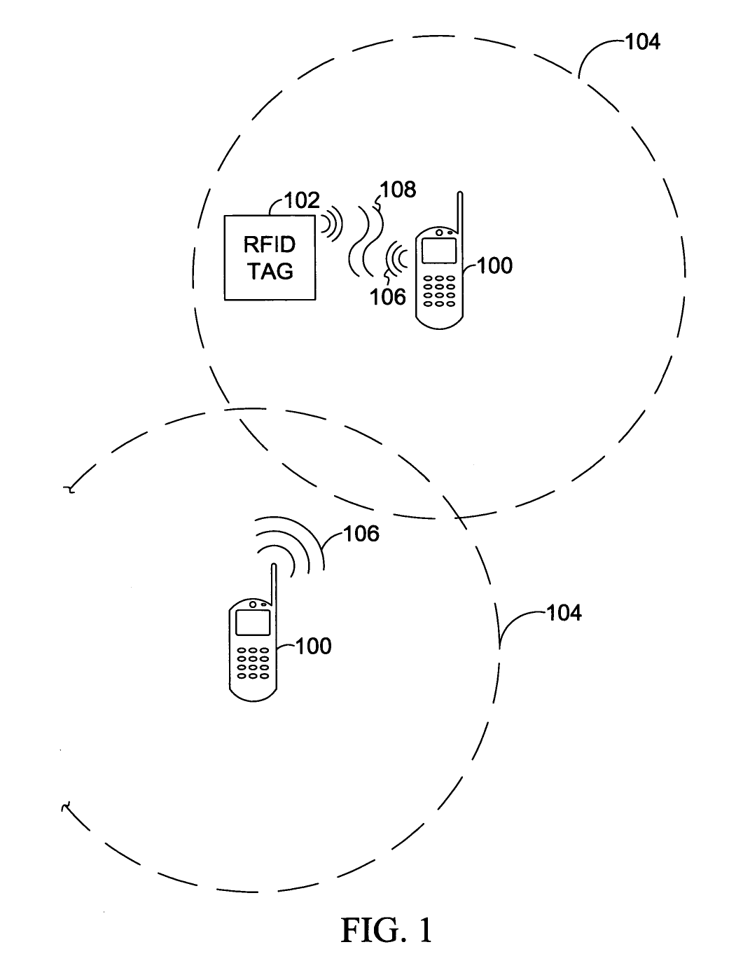

Referring to FIGS. 1 through 8, a system for providing call forwarding from a mobile communication device, specifically mobile telephone 100, to a telephone number associated with a radio frequency identification (RFID) device, such as an RFID tag 102, or the like, is described in accordance with an exemplary embodiment of the present invention. The mobile telephone 100 provides wireless communication of voice and/or data information with external sources such as a base station, a cellular communication system tower, another mobile communication device, or the like via a wireless communication network. While the mobile communication device is depicted as a mobile telephone 100 for purposes of illustration, it will be appreciated that the mobile communication device may alternatively comprise a satellite telephone, a PDA, a palm top computer, a portable gaming device, or another device equipped to receive incoming telephone calls and sized to be held within a user's hand without departing from the scope and intent of the present invention.

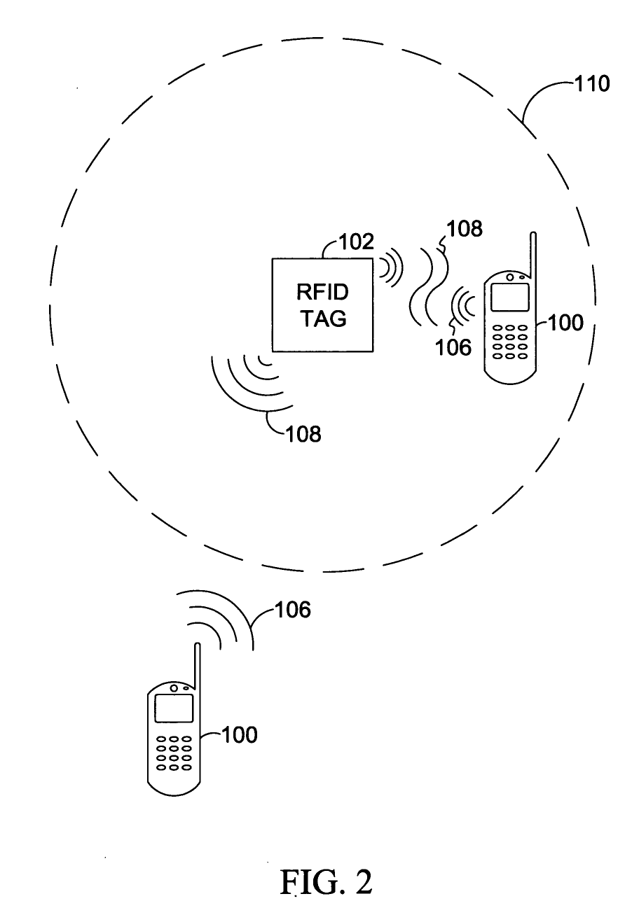

Referring now to FIGS. 1 and 2, the mobile telephone 100 interrogates the RFID tag 102 via an interrogatory radio frequency (RF) signal when the mobile telephone is in proximity to the RFID tag 102. The RFID tag 102 then transmits an RF response signal including identifying information for identifying a telephone number to the mobile telephone 100. In exemplary embodiments of the present invention, the identifying information may include an identification code, a telephone number, a pointer, or the like. The mobile telephone 100 selectively provides call forwarding to a telephone number identified from the identifier provided by the RFID tag 102. In this manner, the RFID tag 102 is associated with the telephone number, allowing the mobile telephone 100 to provide call forwarding to the telephone number when the mobile telephone 100 is in proximity to the RFID tag 102.

Generally, the mobile telephone 100 is in proximity to the RFID tag 102 when the RFID tag 102 is capable of receiving the interrogatory RF signal from the mobile telephone 100 and the mobile telephone 100 is capable of receiving the RF response signal from the RFID tag 102. For example, in one specific embodiment depicted in FIG. 1, a range 104 corresponds with the transmission range of the mobile telephone 100. In this embodiment, the RFID tag 102 receives an interrogatory RF signal 106 when the RFID tag 102 is within the range 104 of the mobile telephone 100. The RFID tag 102 then transmits an RF response signal 108 including the identifying information. Conversely, when the mobile telephone 100 is not in proximity to the RFID tag 102, e.g. when the RFID tag 102 is not within the range 104, the RFID tag 102 does not receive the interrogatory RF signal 106 and does not respond with the RF response signal 108.

In another specific embodiment depicted in FIG. 2, a range 110 corresponds with the transmission range of the RFID tag 102. As previously described in the discussion of FIG. 1, the RFID tag 102 receives the interrogatory RF signal 106 when the RFID tag 102 is within the transmission range of the mobile telephone 100. The RFID tag 102 then transmits the RF response signal 108 including the identifying information. When the mobile telephone 100 is in proximity to the RFID tag 102, e.g. when the mobile telephone 100 is within the range 110, the mobile telephone 100 receives the RF response signal 108. Conversely, when the mobile telephone 100 is not in proximity to the RFID tag 102, e.g. when the mobile telephone 100 is not within the range 110, the mobile telephone 100 does not receive the RF response signal 108.

In exemplary embodiments, the RFID tag 102 comprises a self-contained component that may be affixed to the housing of the land-line telephone or attached to, mounted to a wall of a room within a home or office or attached to furniture within the room, placed in the interior of an automobile having an integral wireless telephone system, or the like. In this manner, may be retrofitted to support automatic call forwarding from mobile telephones without significant modification of existing telephony equipment or infrastructure (e.g., replacement of existing land-line telephones within a telephone network).

In one embodiment, the RFID tag 102 includes a housing enclosing or encapsulating an integrated circuit (IC) connected to an antenna or a like device for receiving and/or transmitting RF signals. Those of skill in the art will appreciate that although the RFID tag 102 has been described with some specificity to include a receiver and transmitter, in an alternative embodiment the RFID tag 102 may continuously transmit identifying information, such as periodically transmitting an identification code, a telephone number, a pointer, or the like. In this alternative embodiment, the RFID tag 102 may not include a receiver for receiving RF signals from the mobile telephone 100, and the mobile telephone 100 may not include a transmitter for transmitting RF signals to the RFID tag 102. In such embodiments, the mobile telephone 100 is configured for receiving an RF signal from the RFID tag 102, such as the RF response signal 108, regardless of whether an interrogatory RF signal, such as the interrogatory RF signal 106, has been transmitted to the RFID tag 102.

The RFID tag 102 may include hardware, software, firmware, (e.g. instructions included with a Read Only Memory (ROM) IC chip), Electrically Eraseable Programmable Read Only Memory (EEPROM), Random Access Memory (RAM) including Synchronous Dynamic RAM (SDRAM) and Rambus Dynamic RAM (RDRAM), and the like for storing the identifier to be transmitted to the mobile telephone 100. Those of skill in the art will appreciate that other techniques may be utilized as well for storing an identifier without departing from the scope and intent of the present invention. Further, while the RFID tag 102 depicted in the accompanying description includes an IC chip connected to an antenna or a like device, those of skill in the art will appreciate that an RFID device for receiving and/or transmitting RF signals in accordance with the present invention may utilize other hardware without departing from the scope and spirit thereof.

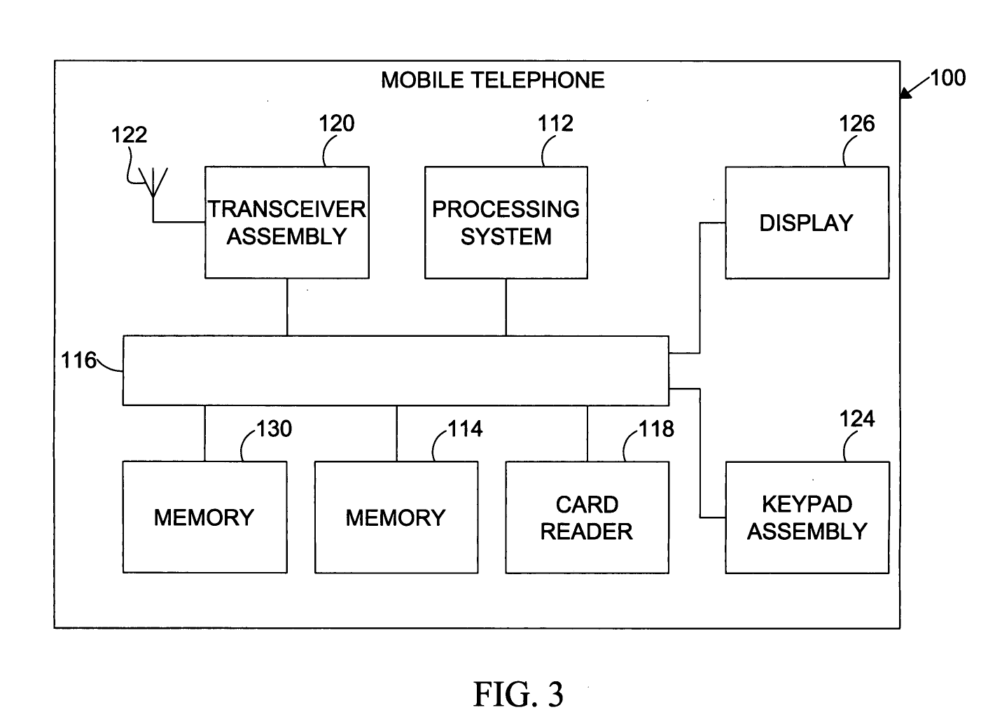

As shown in FIG. 3, the mobile telephone 100 includes a processing system 112 which controls the overall operation of the mobile telephone 100. The processing system 112 may include a general-purpose microprocessor, a digital signal processor (DSP), an application specific integrated circuit (ASIC), or the like. Exemplary processors include the Advanced RISC Machines (ARM®) microprocessor and the Intel 186 processor which are currently used in mobile cellular telephones.

Memory 114 is coupled to the processing system 112 (e.g., via a bus or like interface 116) for storing information including the operating system utilized by the mobile telephone 100, address books, personal greetings, and the like. The memory 114 may comprise both non-volatile and volatile storage devices. In various embodiments, memory 114 utilized by the mobile telephone 100 may include random access memory (RAM), read-only memory (ROM), programmable erasable ROM, flash memory, and the like. Similarly, a data card reader 118 may be coupled to the processing system 112 via the interface 116 for receiving a removable data card providing additional memory for storing information including but not limited to telephone number information for the mobile telephone 100, address book information, security information, and the like. Exemplary data cards include subscriber identification module (SIM) cards, user identification module (UIM) cards, and the like.

A transceiver assembly 120, including a transmitter and receiver or transceiver and an antenna 122 transmit and receive data, including audio data and various other types of data such as text messaging utilized through a wireless communication network (e.g. the base station, the cellular communication system tower, another mobile communication device, or the like). The transceiver assembly 120 may further include signal conditioning circuitry (e.g., analog-to-digital converters, digital-to-analog converters), input/output buffer, and the like.

The mobile telephone 100 may further include input device such as a keypad assembly 124, or the like, for entry of alphanumeric information (e.g., telephone numbers, text messages, etc.), commands, and the like by the user. Similarly, a display 126 may be provided for displaying alphanumeric text, control menus (e.g., via a graphic user interface), prompts, and the like to the user. In exemplary embodiments, the mobile telephone 100 may further include common telephone components such as a microphone, a speaker, a ringer, a vibrator, and the like, which are not illustrated. Additionally, it is contemplated that the mobile telephone 100 may provide functions other than telephony. For example, the mobile telephone may provide functions common to handheld computers or personal digital assistants (PDAs), portable gaming devices, or the like. In such embodiments, the mobile telephone 100 further includes a suitable processing system, extended memory, a touch screen overlaying display for tactile input of data, or the like.

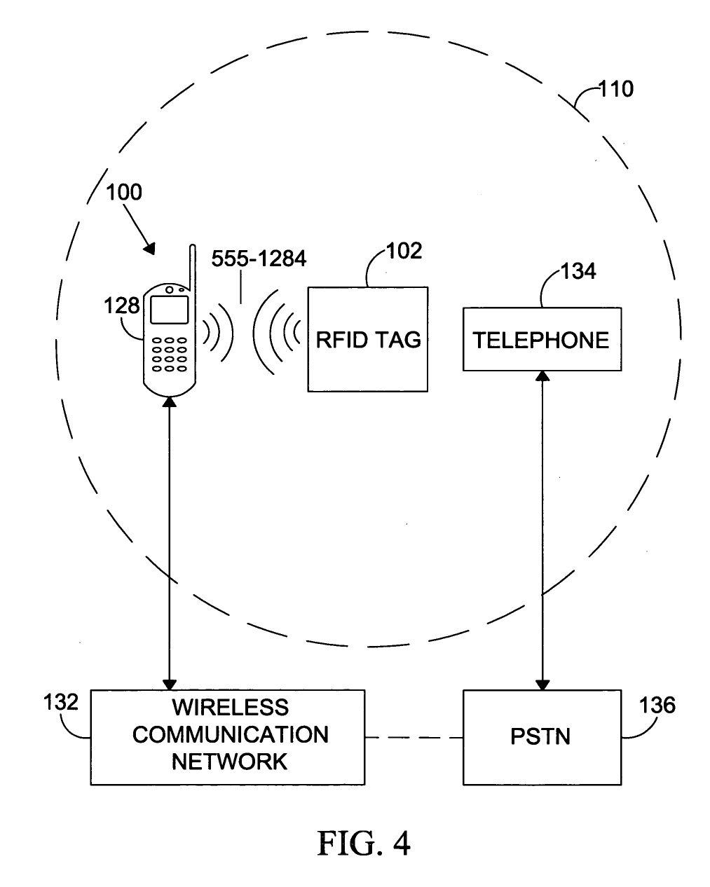

As shown in FIG. 4, the mobile telephone 100 includes a housing 128 sized to be held within the hand of a user. The transceiver assembly 120 is at least substantially contained within the housing 128 of the mobile telephone 100. In an exemplary embodiment, an RFID interrogator 130 is also provided within the housing 128 for interrogating the RFID tag 102 via an interrogatory RF signal when the mobile telephone 100 is in proximity to the RFID tag 102. In one embodiment, the RFID interrogator 130 includes an antenna extending from the housing 128. In another embodiment, the RFID interrogator 130 is an Integrated Circuit (IC) including an antenna. In a still further embodiment, the RFID interrogator 130 is coupled with the antenna 122.

Those of skill in the art will appreciate that while the mobile telephone 100 illustrated in the accompanying figures includes a separate transceiver assembly 120 and RFID interrogator 130, the transceiver assembly 120 may alternatively comprise the RFID interrogator 130, being configured for interrogating the RFID tag 102 via an interrogatory RF signal when the mobile telephone 100 is in proximity to the RFID tag 102. In another embodiment, the mobile telephone 100 may not include a transmitter for transmitting RF signals to the RFID tag 102. In this embodiment, the RFID interrogator 130 (or the transceiver assembly 120) is configured for receiving an RF signal from the RFID tag 102.

In exemplary embodiments, the transceiver assembly 120 is configured for communicating information with a wireless communication network 132, e.g. a General Packet Radio Service (GPRS) bearer service, a Global System for Mobile Communication (GSM) bearer service, an Enhanced Data for GSM Evolution (EDGE) bearer service, a Universal Mobile Telecommunications System (UMTS) bearer service, a Code Division Multiple Access (CDMA) bearer service, a Personal Communications Service (PCS) bearer service, a Time Division Multiple Access (TDMA) bearer service, or the like. In embodiments, the wireless communication network 132 provides call forwarding from the mobile telephone 100 to a telephone 134 in proximity to the RFID tag 102, such as through another wireless communication network, a Public Switched Telephone Network (PSTN) 136, or the like. In this manner, call forwarding is provided from the mobile telephone 100 to the telephone 134. For instance, in one embodiment, calls are forwarded from the mobile telephone 100 to the telephone 134 via GSM supplementary services signaling.

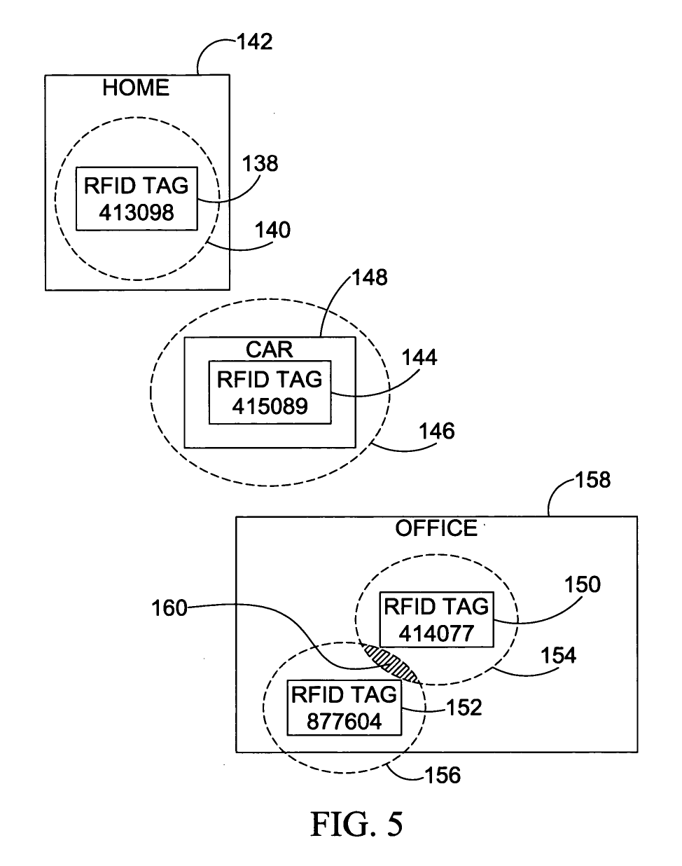

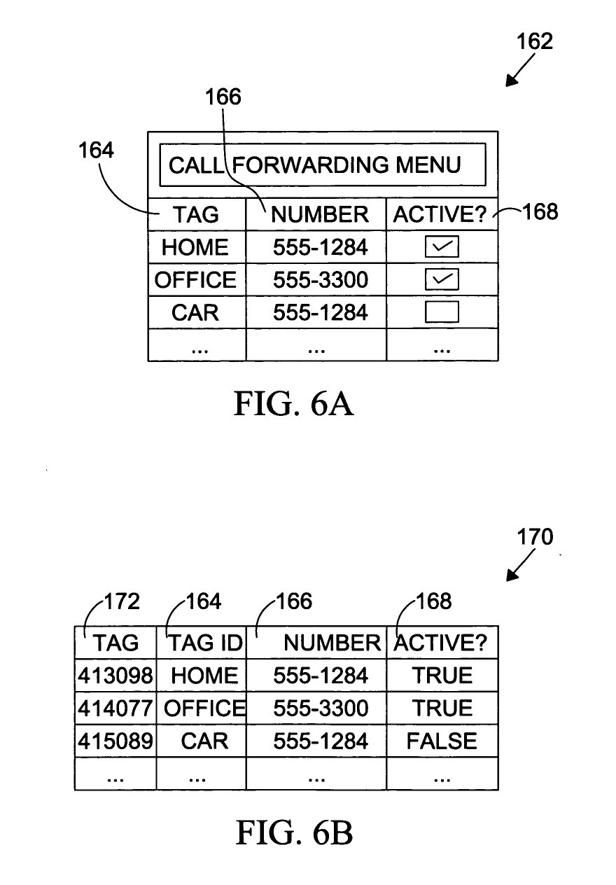

Referring now to FIGS. 5 through 6B, call forwarding may be provided from the mobile telephone 100 to a number of different telephone numbers indicated by a number of different RFID tags. For example, in the embodiment illustrated in FIG. 5, an RFID tag 138 having a first transmission range 140 is located within a user's home 142. Another RFID tag 144 having a second transmission range 146 is placed with a user's car 148, and still more RFID tags 150 and 152 having transmission ranges 154 and 156, respectively, are located within an office building 158. When the mobile telephone is in proximity to any of the RFID tags 138, 144, 150, and 152, call forwarding may be selectively provided to a telephone number indicated by an identifier provided by one of the RFID tags 138, 144, 150, and 152.

In the case of transmission ranges which may overlap, as illustrated by region 160 within the ranges 154 and 156 of RFID tags 150 and 152, respectively, the processing system 112 of the mobile telephone 100 may be provided with a conflict resolution algorithm, or the like, for determining which telephone number indicated by the RFID tags 150 and 152 to forward an incoming telephone call to. In one embodiment, the mobile telephone 100 may forward the call to the telephone number indicated by the RFID tag having the strongest signal, while in another embodiment, the user may rank the RFID tags in order of preference. In this embodiment, when the mobile telephone 100 is in range of both RFID tags 150 and 152, a telephone number indicated by one of the two RFID tags 150 and 152 will be selected over a telephone number provided by the other of the RFID tags 150 and 152. In a still further embodiment, the mobile telephone 100 may select which telephone number indicated by the RFID tags 150 and 152 to forward an incoming call to by examining the telephone number of the incoming call. The telephone number of the incoming call may be determined by utilizing a Caller Identification (caller ID) service, or the like. In this embodiment, the user may associate telephone numbers for incoming calls with preferential telephone numbers provided by RFID tags.

In a still further embodiment, the user may be presented with a visual or auditory prompt via the mobile telephone 100 and asked to select a preferential number for forwarding the telephone call to. If the user does not respond in a certain pre-specified period of time, the telephone call may be forwarded to one of the two numbers indicated by the RFID tags 150 and 152 via a determination made by the processing system 112. Those of skill in the art will appreciate that various other techniques may be provided for resolving conflicts when the mobile telephone 100 is within transmission range of more than one RFID tag without departing from the scope and intent of the present invention, including the measurement of Doppler frequency shifting for determining a user's direction, triangulation of multiple RFID signals, and the like. Further, it will be appreciated that while the present example includes region 160 within the ranges 154 and 156 of RFID tags 150 and 152, respectively, a region within the transmission ranges of multiple RFID tags may include the transmission ranges of more than two RFID tags.

Referring now to FIGS. 6A and 6B, a user of the mobile telephone 100 may be presented with a call forwarding menu 162 for indicating preferential actions for selectively call forwarding a telephone call to a telephone number indicated by an RFID tag. In the exemplary embodiment illustrated in FIG. 6A, the call forwarding menu 162 includes RFID tag designations 164, telephone numbers 166 associated with the RFID tag designations 164, and another associated field 168 for indicating whether call forwarding is to be enabled when a signal is received from one of the RFID tags identified by the RFID tag designations 164. The data contained in fields 164 through 168 may be specified and/or modified by a user for selectively providing call forwarding.

The information contained in fields 164 through 168 and displayed in the call forwarding menu 162 may be stored in a database 170. The database 170 may reside in the memory 114 of the mobile telephone 100, may be downloaded from the mobile communication network 132, or may be supplied by an RFID tag. The database 170 may include RFID tag identification codes 172, the RFID tag designations 164, the telephone numbers 166 associated with the RFID tag designations 164, and the associated field 168 for indicating whether call forwarding is to be enabled when a signal is received from one of the RFID tags identified by the RFID tag designations 164.

In an exemplary embodiment, an RFID tag transmits one of the RFID tag identification codes 172 to the mobile telephone 100, and the mobile telephone 100 selectively provides call forwarding based on the identification code of the RFID tag. It will be appreciated, however, that in another embodiment, an RFID tag may transmit a telephone number, and the mobile telephone 100 may selectively enable call forwarding based on the telephone number. In a still further embodiment, an RFID tag may transmit a pointer, such as a binary number, or the like, which the mobile telephone associates with a telephone number for selectively providing call forwarding.

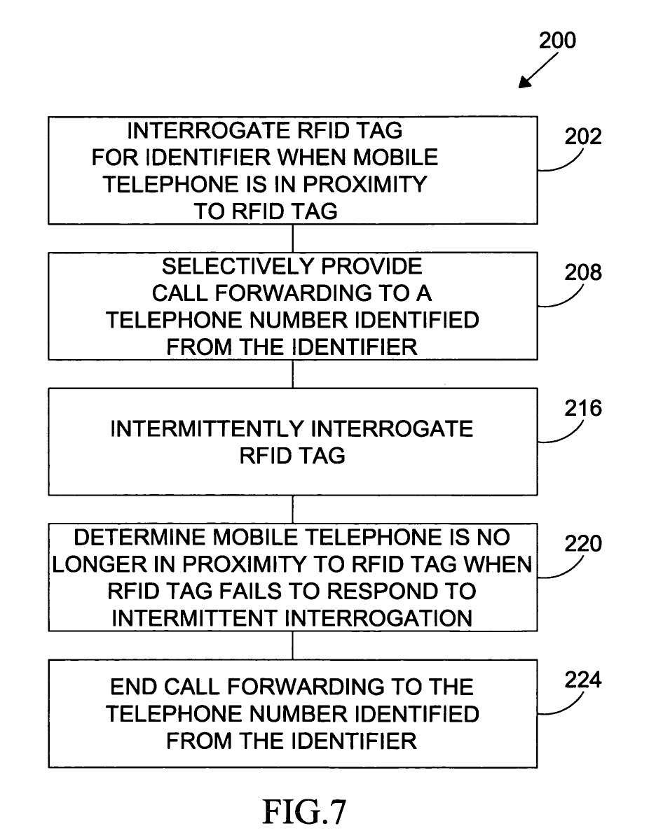

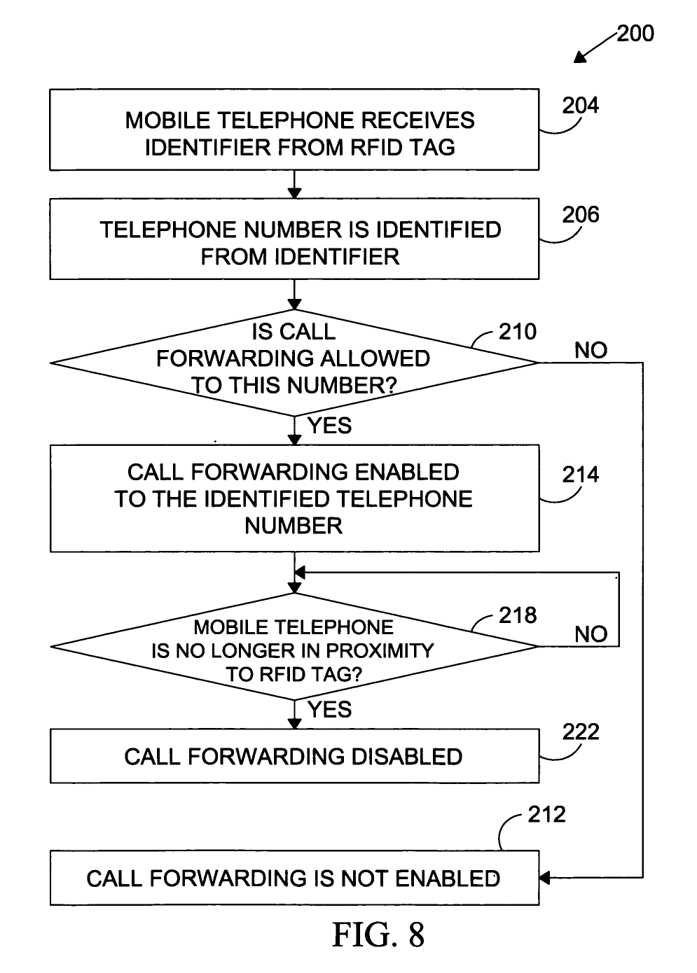

Referring to FIGS. 7 and 8, a method 200 for selectively providing call forwarding from a mobile telephone to a telephone number is described in accordance with an exemplary embodiment of the present invention. First, an RFID tag in proximity to the mobile telephone and associated with a telephone number is interrogated by the mobile telephone, 202. Then, the mobile telephone receives an identifier from the RFID tag, 204. The identifier, such as an identification code, a telephone number, or a pointer, is utilized to determine the telephone number associated with the RFID tag, 206. Then, call forwarding is selectively provided to the telephone number identified from the identifier provided by the RFID tag, 208. For example, the mobile telephone makes a determination (such as utilizing the database described in FIG. 6B) as to whether call forwarding is allowed to the identified telephone number, 210. If call forwarding is not allowed to the identified telephone number 210, call forwarding is not enabled from the mobile telephone to the identified telephone number, 212. If, however, the determination is made that call forwarding is allowed to the identified telephone number, call forwarding is enabled to the telephone number, 214. If call forwarding has been enabled, the mobile telephone 100 intermittently interrogates the RFID tag, 216, in order to make a determination as to whether the mobile telephone is still in proximity to the RFID tag, 218. When the RFID tag fails to respond to the intermittent interrogation (or the mobile telephone is no longer within the transmission range of the RFID tag), call forwarding is disabled to the identified telephone number, 222. Thus, call forwarding to the identified telephone number has been ended, 224.

In the exemplary embodiments, method 200 may be implemented as sets of instructions or software readable by the processing system 112 of the mobile telephone 100. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for selectively providing call forwarding from a mobile telephone to a telephone number, comprising:
interrogating an RFID device associated with the telephone for an identifier when the mobile telephone is in proximity to the RFID device, the identifier for identifying the telephone number to the mobile telephone; and
selectively providing call forwarding from the mobile telephone to the identified telephone number.

2. The method as claimed in claim 1, wherein the identifier provided by the RFID device comprises the telephone number.

3. The method as claimed in claim 2, wherein the mobile telephone includes a list comprising at least one telephone number for selective call forwarding, and the method further comprises the step of determining if the telephone number associated with the interrogated RFID device is included in the list.

4. The method as claimed in claim 1, wherein the identifier comprises a pointer for selecting a telephone number stored in memory of the mobile telephone or provided to the mobile telephone via a wireless communication network.

5. The method as claimed in claim 4, wherein the mobile telephone compares the pointer with a list of pointers cross-referenced with telephone numbers for call forwarding for determining if the pointer is included in the list.

6. The method as claimed in claim 1, wherein the mobile telephone includes a transceiver assembly for interrogating the RFID device, the transceiver assembly being at least substantially contained within a housing of the mobile telephone.

7. The method as claimed in claim 1, further comprising alternately enabling and disabling the call forwarding function of the mobile telephone, wherein call forwarding is provided to the second telephone when call forwarding function is enabled.

8. The method as claimed in claim 1, further comprising:
intermittently interrogating the RFID device,
determining when the mobile telephone is no longer in proximity to the RFID device when the RFID device fails to respond to the intermittent interrogation, and
ending call forwarding to the second telephone upon determining that the mobile telephone is no longer in proximity to the RFID device.

9. A mobile communication device for selectively providing call forwarding to a telephone number associated with an RFID device when the mobile communication device is located in proximity to the RFID device, comprising:
a housing sized to be held within the hand of a user; and
a transceiver assembly at least substantially contained within the housing for interrogating the RFID device for an identifier,
wherein call forwarding is selectively provided from the mobile communication device to the telephone number upon recognition of the identifier.

10. The mobile communication device as claimed in claim 9, wherein the identifier provided by the RFID device comprises the telephone number.

11. The mobile communication device as claimed in claim 9, further comprising memory for storing a list including at least one telephone number for selective call forwarding, wherein the call forwarding is provided if the telephone number associated with the interrogated RFID device is included in the list.

12. The mobile communication device as claimed in claim 9, wherein the identifier comprises a pointer for selecting a telephone number stored in memory of the mobile communication device or provided to the mobile communication device via a wireless communication network.

13. The mobile communication device as claimed in claim 9, wherein the mobile communication device includes a control for alternately enabling and disabling the call forwarding.

14. The mobile communication device as claimed in claim 9, wherein the transceiver assembly intermittently interrogates the RFID device, and when the RFID device fails to respond to the intermittent interrogation the call forwarding is disabled.

15. A system for selectively providing call forwarding, comprising:
an RFID device having an identifier associated with a telephone number;
a mobile communication device having a transceiver assembly for interrogating the RFID device for the identifier when the mobile communication device is located in proximity to the RFID device,
wherein the mobile communication device selectively enables call forwarding to the telephone number upon recognition of the identifier.

16. The system as claimed in claim 15, wherein the identifier provided by the RFID device comprises the telephone number.

17. The system as claimed in claim 15, further comprising memory for storing a list including at least one telephone number for selective call forwarding, wherein the call forwarding is provided if the telephone number associated with the interrogated RFID device is included in the list.

18. The system as claimed in claim 15, wherein the identifier comprises a pointer for selecting a telephone number stored in memory of the mobile communication device or provided to the mobile communication device via a wireless communication network.

19. The system as claimed in claim 15, wherein the mobile communication device includes a control for alternately enabling and disabling the call forwarding.

20. The system as claimed in claim 15, wherein the transceiver assembly intermittently interrogates the RFID device, and when the RFID device fails to respond to the intermittent interrogation the call forwarding is disabled.
